(19) United States
(12) Patent Application Publication
(10) Pub. No.: US 2005/0254396 A1
(43) Pub. Date: Nov. 17, 2005

(54) Optical communication device

(75) Inventor: Shinji Tsukamoto, Saitama-ken (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/121,016

(22) Filed: May 4, 2005

(30) Foreign Application Priority Data
May 11, 2004 (JP) 2004-140624

(51) Int. Cl. G11B 7/00

(52) U.S. Cl. 369/112.01; 369/112.27; 369/44.27

(57) ABSTRACT

An optical communication device comprises a light source, an optical fiber, a condenser lens condensing a beam from the light source to form a spot on the fiber's incidence face, a moving system moving the spot in non-parallel two directions, a photoreceiving system having first and second areas separated by a first boundary line and third and fourth areas separated by a second boundary line, and a control system controlling the moving system to move the spot so that a first output difference (output of the third area minus that of the fourth area) will be substantially equal to a first reference value and a second output difference (output of the first area minus that of the second area) will be substantially equal to a second reference value. By the optical communication device, initial positioning of the spot to the core of the fiber is executed simply and quickly.

### BACKGROUND OF THE INVENTION

The present invention relates to a composition of an optical communication device for carrying out optical communication using light emitted by an LD (Laser Diode).

Optical communication devices transmit/receive a laser beam (emitted by an LD and modulated according to information to be transmitted) through an optical fiber. An optical communication device generally includes optical elements like an LD, a lens for collecting the beam emitted by the LD, an optical fiber, etc. An optical communication module used as an ONU (Optical Network Unit) for leading optical fibers into subscriber premises generally further includes a photoreceptor, a WDM (Wavelength Division Multiplex) filter for separating light depending on the wavelength, etc. in order to support two-way communication (transmission and reception via an optical fiber).

In such an optical communication module, the LD is positioned precisely with respect to the optical fiber (having a core diameter of several micrometers) in order to focus the beam from the LD approximately at the center of the core of the fiber. The optical elements are generally fixed firmly by welding or with adhesives inside a casing of the optical communication module. An example of a conventional method for an arrangement of the optical elements is described in Japanese Patent Provisional Publication No. HEI 06-94947.

In the positioning method described in the above publication, the amount of light emerging from the optical fiber is detected and the beam from the LD is judged to be incident upon the approximate center of the core when the detected light amount reaches its maximum.

However, it is generally difficult to identify the boundary between the core and clad of an optical fiber on the fiber's incidence face (upon which the beam is incident). Further, the core is extremely smaller than the clad on the incidence face. Therefore, in order to employ the positioning method of the above-identified publication, initial positioning for adjusting positional relationship between the LD and the optical fiber has to be repeated in a trial-and-error manner until the amount of light emerging from the optical fiber is detected. Such a process is inefficient and takes a long time.

### SUMMARY OF THE INVENTION

The present invention is advantageous in that there is provided an optical communication device capable of executing initial positioning (for leading the beam emitted by the LD to the core of the fiber's incidence face) simply and quickly.

According to an aspect of the present invention, there is provided an optical communication device, which is provided with a light source which emits a beam of light modulated according to information, an optical fiber having an incidence face upon which the beam is incident and transmitting the beam entering its core, a condenser lens placed on an optical path of the beam between the light source and the optical fiber to condense the beam to let it form a spot on the incidence face, a moving system which moves the spot on the incidence face in a first direction and a second direction which are not parallel with each other, a photoreceiving system including a photoreceiving surface having first and second areas separated from each other by a first boundary line extending in a direction corresponding to the first direction and third and fourth areas separated from each other by a second boundary line extending in a direction corresponding to the second direction, outputting a signal corresponding to intensity of light received by each of the first through fourth areas after being reflected by the incidence face, and a control system which controls the moving system to move the spot in the first direction so that a first output difference obtained by subtracting the output of the fourth area from that of the third area will be substantially equal to a first reference value while controlling the moving system to move the spot in the second direction so that a second output difference obtained by subtracting the output of the second area from that of the first area will be substantially equal to a second reference value.

In a preferred embodiment, the first output difference takes on a value larger than the first reference value when incidence position of the reflected beam on the photoreceiving surface has a shift toward the third area with reference to the second boundary line while taking on a value smaller than the first reference value when the incidence position has a shift toward the fourth area with reference to the second boundary line, and the second output difference takes on a value larger than the second reference value when incidence position of the reflected beam on the photoreceiving surface has a shift toward the first area with reference to the first boundary line while taking on a value smaller than the second reference value when the incidence position has a shift toward the second area with reference to the first boundary line. Specifically, each of the first and second output differences varies substantially in a linear relationship with a shift of beam incidence position (spot position) from the core on the incidence face.

For executing the initial positioning of the spot (formed on the optical fiber's incidence face by the beam from the light source) to the core more simply and quickly, it is desirable that the first direction and the second direction be orthogonal to each other. Preferably, the reflected beam from the center of the core is incident upon the intersection point of the first and second boundary lines when the first and second output differences coincide with the first and second reference values respectively.

In order to reduce the load on the control system, it is desirable that at least one of the first and second reference values (preferably, both the first and second reference values) be set at 0(V). When a reference value is 0, the aforementioned judgment (on which side of the imaginary line the spot lies) can be made based on whether the first output difference is positive or negative.

The moving system may be configured to move the spot in the first direction and the second direction by driving the condenser lens. The moving system may also be configured to move the spot in the first direction and the second direction by moving the light source. The moving system may also be implemented by a transmissive deflecting member (e.g. variable apex angle prism) placed between the light source and the fiber's incidence face.

Preferably, the incidence face of the optical fiber is provided with a prescribed level difference between the core and the clad to cause diffraction to the reflected beam.

It is desirable that the level difference be set smaller than λ/(4n), where λ is a wavelength of the beam from the light source and n is a refractive index of a medium. In a preferred embodiment, the level difference is set at approximately λ/(8n). The level difference can be formed either by letting the core protrude from the clad or by letting the core withdraw from the clad. The process for letting the core protrude or withdraw from the clad can be carried out by photolithography. For realizing more precise positioning, the incidence face is processed so that the surface of the core and that of the clad will be substantially parallel with each other.

For letting the reflected beam form a bright and clear (clear-cut) diffraction pattern on the photoreceiving surface, the diameter of the spot formed on the incidence face is desired to be larger than that of the core. However, letting the spot diameter be larger than the diameter of the clad (i.e. the diameter of the incidence face), causing unnecessary loss of light amount, is undesirable.

According to another aspect of the present invention, there is provided an optical communication device which is provided with a light source which emits a beam of light modulated according to information, an optical fiber having an incidence face upon which the beam is incident and transmitting the beam entering its core, a condenser lens placed on an optical path of the beam between the light source and the optical fiber to condense the beam to let it form a spot on the incidence face, a moving system which moves the spot on the incidence face in a first direction and a second direction which are not parallel with each other, a photoreceiving system which outputs a signal indicating distribution of intensity of light received by its photoreceiving surface after being reflected by the incidence face, and a control system which controls the moving system to move the spot in the first direction and the second direction so as to lead the spot to the core based on the light intensity distribution indicated by the signal outputted by the photoreceiving system.

According to a further aspect of the invention, there is provided an optical communication device, which is provided with a light source which emits a beam of light modulated according to information, an optical fiber having an incidence face upon which the beam is incident and transmitting the beam entering its core, a condenser lens placed on an optical path of the beam between the light source and the optical fiber to condense the beam to let it form a spot on the incidence face, a moving system which moves the spot on the incidence face in a first direction and a second direction which are not parallel with each other, a photoreceiving system including a photoreceiving surface having a plurality of two-dimensionally arranged areas, and a control system which controls the moving system to move the spot to a predetermined position on the photoreceiving surface in accordance with outputs of the plurality of two-dimensionally arranged areas.

Optionally, the moving system may be configured to move the spot by shifting the condenser lens in a direction orthogonal to an optical axis of the condenser lens.

### BRIEF DESCRIPTION OF THE ACCOMPANYING DRAWINGS

FIG. 1 is a schematic diagram showing the overall composition of an optical communication module in accordance with an embodiment of the present invention;

FIG. 2 is an enlarged view showing a part of an optical fiber of the optical communication module of FIG. 1 in the vicinity of its incidence face;

FIG. 3 is a schematic diagram showing a photoreceiving surface of a photodetector of the optical communication module of FIG. 1;

FIGS. 4A-4C are schematic diagrams showing relationships between incidence position of a beam emitted by an LD upon the photoreceiving surface measured in an X″ direction and the amount of light received by the photodetector;

FIG. 5 is a graph showing the relationship between the distance from the core of the optical fiber to a beam spot on the incidence face and a first output difference;

FIGS. 6A-6C are schematic diagrams showing various incidence positions of the beam from the LD on the incidence face and light intensity distribution (on the photoreceiving surface) in the X″ direction obtained from outputs of photoreceiving areas;

FIG. 7 is a schematic diagram showing the overall composition of an optical communication module in accordance with another embodiment of the present invention;

FIG. 8 is a graph showing the relationship between the distance from the core to the beam spot on the incidence face and the first output difference in the optical communication module of FIG. 7; and

FIG. 9 is a schematic diagram showing an example of modification of the optical communication module of FIG. 1.

### DETAILED DESCRIPTION OF THE EMBODIMENT

Referring now to the drawings, a description will be given in detail of preferred embodiments in accordance with the present invention.

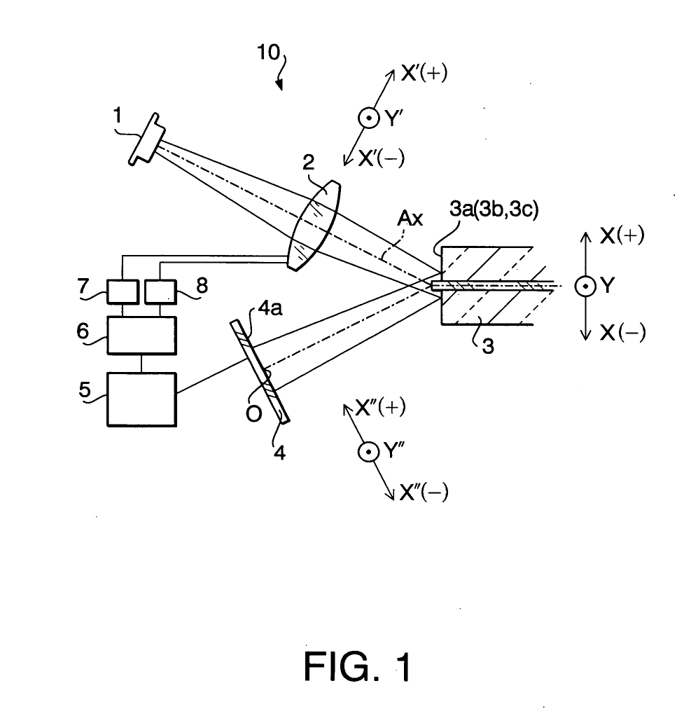

FIG. 1 is a schematic diagram showing the composition of an optical communication module 10 in accordance with an embodiment of the present invention. The optical communication module 10 is used as an ONU (Optical Network Unit) for leading optical fibers into subscriber premises. The optical communication module 10 is a module supporting two-way WDM (Wavelength Division Multiplex) communication, configured to transmit an optical signal of a wavelength of 1.3 μm as an upstream signal and receive an optical signal of a wavelength of 1.5 μm as a downstream signal via an optical fiber, for example. The optical communication module 10 of this embodiment includes an LD (Laser Diode) 1, a condenser lens 2, an optical fiber 3, a photodetector 4, a sense amplifier 5, a controller 6, a first actuator 7 and a second actuator 8. Incidentally, while the incidence angle of the beam from the LD 1 incident upon the optical fiber 3 via the condenser lens 2 is extremely small in actual optical communication modules, the incidence angle is exaggerated in FIG. 1 for the purpose of illustration.

In each drawing, a chain line with a reference character AX denotes a reference axis, which is a phantom line (for explanation) connecting the center of the beam emitting face of the LD 1, the core center and the center of the photodetector 4. The LD 1 and the photodetector 4 are arranged, with respect to the optical fiber 3, such that the reference axis AX substantially satisfies the law of reflection at the incidence face 3a of the optical fiber 3.

The beam emitted by the LD 1 is focused by the condenser lens 2 on the incidence face 3a of the optical fiber 3 and forms a beam spot (hereinafter referred to as a spot). While the LD 1 in actual optical communication emits a beam modulated according to prescribed information (to be transmitted by the communication) under the control of an unshown communication control unit, the LD 1 emits an unmodulated beam during the adjustment of the beam incidence position on the incidence face 3a of the optical fiber 3 which will be described in detail. In other words, the LD 1 stays in a DC emission state during the positioning process. The condenser lens 2 can be moved by the first actuator 7 in a direction (X′ direction) orthogonal to the optical axis of the condenser lens 2 and by the second actuator 8 in a direction (Y′ direction) substantially orthogonal to the X′ direction under the control of the controller 6. Therefore, the spot moves on the incidence face 3a depending on the direction of the movement of the condenser lens 2. The directions of the spot movement corresponding to the movement of the condenser lens 2 in the X′ direction and the Y′ direction will hereinafter be called an X direction and a Y direction, respectively.

In this specification, positional relationships and directions will be described with reference to the moving directions of the spot (X direction, Y direction). In the configuration of this embodiment, when the incidence face 3a is seen from the LD 1, the direction to the right of the core 3c is defined as an X(−) direction and the direction to the left of the core 3c is defined as an X(+) direction. Meanwhile, the direction pointing upward from the core 3c is defined as a Y(+) direction and the direction pointing downward from the core 3c is defined as a Y(−) direction.

Since the beam reflected by the incidence face 3a has to be guided to the photodetector 4, the optical communication module 10 is configured to let the beam from the LD 1 enter the incidence face 3a at an incidence angle other than 0°. Therefore, the optical path of the beam reflected by the incidence face 3a differs from that of the beam entering the incidence face 3a. The beam reflected by the incidence face 3a is then incident upon the photodetector 4.

The optical communication module 10 of this embodiment not only executes the initial positioning (for letting the incident beam enter the core 3c on the incidence face 3a of the optical fiber 3) but also constantly executes high-precision negative feedback control (for letting the spot center of the incident beam coincide with the core center) after the completion of the initial positioning. The high-precision control will hereinafter be referred to as real-time control for the sake of convenience. For the real-time control, the incidence face 3a of the optical fiber 3 is configured as below.

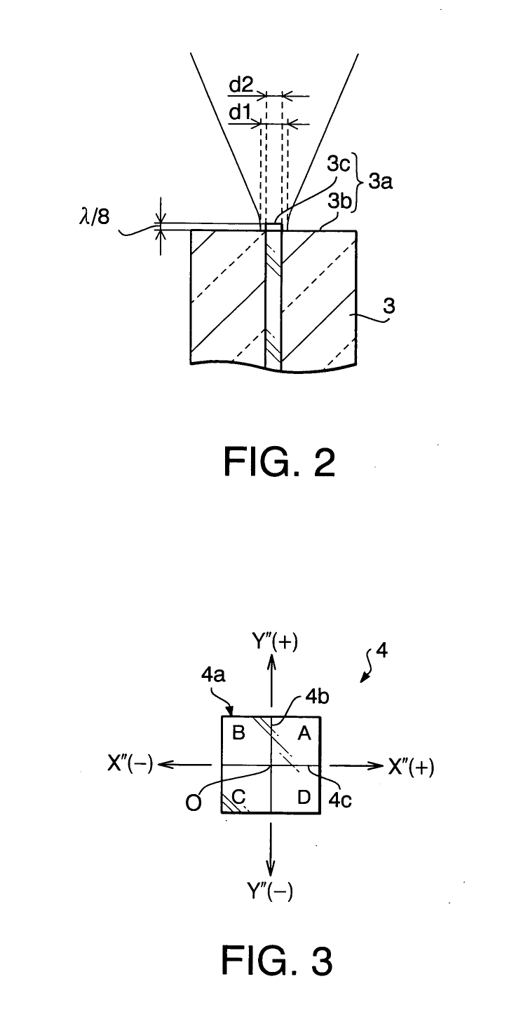

FIG. 2 is an enlarged view showing a part of the optical fiber 3 in the vicinity of the incidence face 3a. The optical fiber 3 includes the core 3c and a clad 3b surrounding the core 3c. In this specification, the center of the core 3c is assumed to coincide with that of the optical fiber 3 for convenience of explanation.

As shown in FIG. 2, the incidence face 3a includes a level difference which is formed by the core 3c protruding from the clad 3b in a direction orthogonal to the surface of the clad 3b (i.e. in the optical axis direction of the optical fiber 3). The incidence face 3a is formed so that the surface of the protruding core 3c and that of the clad 3b will be substantially parallel with each other. In this embodiment, the incidence face 3a is formed in the above configuration by photolithography. The level difference is set smaller than λ/(4n), where λ is the wavelength of the incident beam and n is the refractive index of a medium. By setting the level difference as above, diffraction is caused when the beam (which has been condensed so that the spot diameter d1 will be slightly larger than the core diameter d2) is incident upon both the surface of the protruding core 3c and the surface of the clad 3b. The real-time control is executed using the diffraction. In this embodiment, the level difference is set to approximately λ/8n. When the medium is the air, the level difference is set to approximately λ/8 (n≅1 in air).

The spot size of the beam emitted by the LD 1 is generally defined as a range within which light intensity remains higher than 1/e² (e: the base of natural logarithms) of the maximum intensity in the light intensity distribution. It is well known that the diffraction pattern is formed more clearly as the light intensity of the beam gets higher. The effects of interference between beams gets more prominent as the difference of amplitude between the interacting beams gets smaller. Incidentally, even a part of the incident beam having light intensity lower than 1/e² of the maximum intensity can form a diffraction pattern on a photoreceiving surface 4a of the photodetector 4.

Therefore, when the spot and the core 3c formed on the incidence face 3a coincide with each other, the effect of diffraction on a light intensity distribution pattern formed on the photoreceiving surface 4a diminishes while incidence efficiency of the beam reaches its maximum. On the other hand, when the optical communication module 10 is designed to enhance the effect of diffraction on the light intensity distribution pattern, the spot diameter on the incidence face 3a is made larger, by which the amount of light entering the optical fiber 3 decreases, reducing coupling efficiency between the LD 1 and the optical fiber 3.

In consideration of the above conditions, the optical communication module 10 of this embodiment is designed so that the spot diameter d1 on the incidence face 3a will be slightly larger than the core diameter d2 on the incidence face 3a as shown in FIG. 2 in order to balance the clarity of the diffraction pattern (i.e. the enhancement of the effect of diffraction on the light intensity distribution pattern necessary for the high-precision real-time control) with high coupling efficiency necessary for realizing high-precision optical communication. Therefore, even when the beam is incident upon a part of the incidence face 3a having the maximum optical transmission efficiency (i.e. the core 3c), a peripheral part of the spot is incident upon the clad 3b. In this embodiment, the spot diameter d1 and the core diameter d2 are set to 11 μm and 10 μm, for example. Incidentally, the real-time control for letting the spot center coincide with the core center is also possible even when the spot diameter d1 is set smaller than the core diameter d2 (letting the spot be contained in the core 3c on the incidence face 3a). The real-time control, employing the diffraction caused by the level difference between the clad 3b and the core 3c, will be explained in detail later.

The photodetector 4 in this embodiment is implemented by a four-part split photodetector. Specifically, as shown in FIG. 3, which is a front view of the photodetector 4, the photoreceiving surface 4a is split into four photoreceiving areas A-D (arranged like a matrix) by two boundary lines 4b and 4c intersecting orthogonally at the center O of the photoreceiving surface 4a. In regard to the photodetector 4, the directions of the two boundary lines 4b and 4c are defined as an X″ direction and a Y″ direction, respectively. In this embodiment, the photodetector 4 is placed so that directions of movement of the light intensity distribution pattern (formed on the photoreceiving surface 4a) caused by movement of the spot (formed on the incidence face 3a) in the X direction and the Y direction will coincide with the X″ direction and the Y″ direction. Between the incidence face 3a and the photodetector 4, a proper optical system (unshown) is placed for letting the reflected beam (the beam reflected by the incidence face 3a) enter the four photoreceiving areas A-D.

Specifically, with respect to the boundary line 4b (passing through the center O of the photoreceiving surface 4a and extending in the Y″ direction), the photoreceiving areas A and D are situated on the X″(+) direction, while the photoreceiving areas B and C are situated on the X″(−) direction. Similarly, with respect to the boundary line 4c (passing through the center O of the photoreceiving surface 4a and extending in the X″ direction), the photoreceiving areas A and B are situated on the Y″(+) direction, while the photoreceiving areas C and D are situated on the Y″(−) direction. In the following description, the photoreceiving areas A and D are generically called as an X″(+) area, the photoreceiving areas B and C are generically called as an X″(−) area, the photoreceiving areas A and B are generically called as a Y″(+) area, and the photoreceiving areas C and D are generically called as a Y″(−) area, for convenience of explanation.

The photodetector 4 generates voltage signals (each of which corresponds to the amount of light received by each photoreceiving area A-D) and outputs the voltage signals to the sense amplifier 5. The sense amplifier 5 amplifies each voltage signal to a prescribed level as needed and sends the voltage signals to the controller 6.

The controller 6 executes the initial positioning (for letting the spot (formed on the incidence face 3a by the beam from the LD 1) lie in the vicinity of the core 3c) by driving and controlling the condenser lens 2 according to a principle which will be described in detail below.

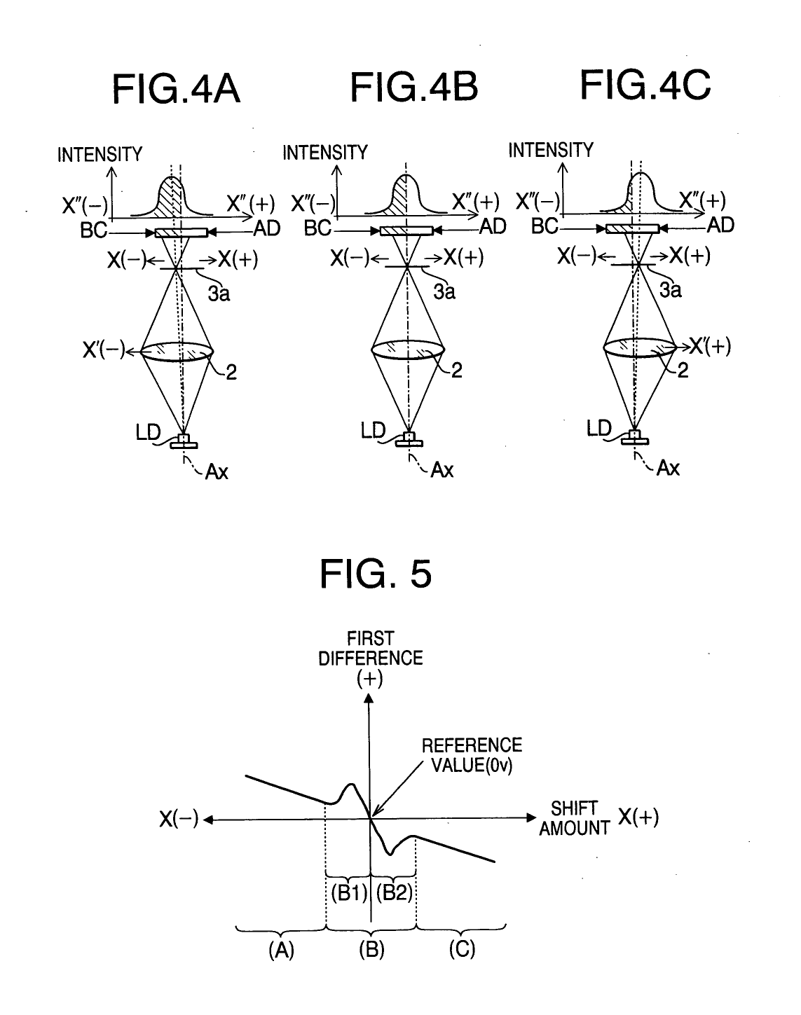

First, a principle for the initial positioning in the X direction executed by the controller 6 will be explained below. FIGS. 4A-4C are schematic diagrams showing relationships between the incidence position of the beam emitted by the LD 1 upon the photoreceiving surface 4a measured in the X″ direction (a shift of the optical axis of the condenser lens 2 from the reference axis AX in the X′ direction) and the amount of light received by the photodetector 4. The graphs in the upper parts of FIGS. 4A-4C indicate the amount of light received by each photoreceiving area of the photodetector 4. The lower parts of FIGS. 4A-4C indicate optical paths (seen in cross-sectional views) of the beam emitted by the LD 1 and incident upon the photoreceiving surface 4a via the condenser lens 2 and the incidence face 3a. Specifically, FIG. 4A shows a state in which the beam from the LD 1 is forming a spot on a part of the incidence face 3a on the X(−) side of the core 3c. FIG. 4B shows a state in which the spot substantially coincides with the core 3c. FIG. 4C shows a state in which the beam from the LD 1 is forming a spot on a part of the incidence face 3a on the X(+) side of the core 3c.

As shown in FIG. 4A, when the condenser lens 2 is shifted in the X′(−) direction, the reflected beam from the incidence face 3a is incident upon the photoreceiving surface 4a deviating from the reference axis AX in the X″(−) direction, by which the amount of light received by the X″(−) area of the photoreceiving surface 4a gets larger than the amount of light received by the X″(+) area. On the other hand, as shown in FIG. 4C, when the condenser lens 2 is shifted in the X′(+) direction, the reflected beam from the incidence face 3a is incident upon the photoreceiving surface 4a deviating from the reference axis AX in the X″(+) direction, by which the amount of light received by the X″(+) area gets larger than the amount of light received by the X″(−) area. As shown in FIG. 4B, when the beam from the LD 1 is incident upon the approximate center of the incidence face 3a (i.e. a part in the vicinity of the core 3c), the amount of received light does not differ between the X″(+) area and the X″(−) area.

As shown in FIGS. 4A-4C, the amount of light received by each area varies depending on the position of the spot on the incidence face 3a, that is, varies corresponding to the shift of the spot with respect to the core 3c. FIG. 5 shows the relationship between the distance from the core 3c to the spot and the difference between the output of the X″(−) area and that of the X″(+) area (i.e., a first output difference=(B+C)−(A+D)). Zones (A), (B) and (C) shown in FIG. 5 correspond to the incidence states (of the reflected beam incident upon the photodetector 4) shown in FIGS. 4A, 4B and 4C, respectively.

When the reflected beam is incident upon the photodetector 4 in the state of FIG. 4A, the output of the X″(−) area gets larger than that of the X″(+) area, by which the first output difference is obtained as a positive voltage. On the other hand, when the reflected beam is incident upon the photodetector 4 in the state of FIG. 4C, the output of the X″(+) area gets larger than that of the X″(−) area, by which the first output difference is obtained as a negative voltage. When the reflected beam is incident upon the photodetector 4 in the state of FIG. 4B, the output of the X″(−) area substantially equals that of the X″(+) area, by which the first output difference is obtained as a voltage in the vicinity of 0 V. In this embodiment, the spot center coincides with the core center and the efficiency of optical communication reaches its maximum when the first output difference is 0 V. Therefore, the first output difference 0 V is called a first reference value in this embodiment.

As above, the shift of the spot from the core 3c in the X direction on the incidence face 3a can be detected from the first output difference. The direction of the shift of the spot with reference to the core 3c (X(−) or X(+)) can be judged from the sign (+ or −) of the first output difference. The first output difference varies almost linearly with respect to the shift as shown in FIG. 5. Therefore, the incidence position of the beam on the incidence face 3a can be moved toward the core 3c by calculating the first output difference and executing the drive control of the condenser lens 2 so as to let the first output difference approach the first reference value (0 V in this embodiment). For example, the controller 6 executes a process for the initial positioning in the X direction as explained below.

In the state of FIG. 4A (i.e. in the case where the first output difference is obtained as a positive value), the controller 6 judges that the spot on the incidence face 3a has shifted from the core 3c in the X(−) direction and thereby lets the first actuator 7 move the condenser lens 2 in the X′(+) direction. According to the movement of the condenser lens 2 in the X′(+) direction, the spot on the incidence face 3a moves in the X(+) direction. The controller 6 continues the drive control of the condenser lens 2 until the incidence state of the reflected beam upon the photodetector 4 reaches the state of FIG. 4B, that is, until the first output difference enters a prescribed permissible range around the first reference value.

In the state of FIG. 4C (i.e. in the case where the first output difference is obtained as a negative value), the controller 6 judges that the spot on the incidence face 3a has shifted from the core 3c in the X(+) direction and thereby lets the first actuator 7 move the condenser lens 2 in the X′(−) direction. According to the movement of the condenser lens 2 in the X′(−) direction, the spot on the incidence face 3a moves in the X(−) direction. The controller 6 continues the drive control of the condenser lens 2 until the incidence state of the reflected beam upon the photodetector 4 reaches the state of FIG. 4B, that is, until the first output difference enters the prescribed permissible range around the first reference value.

The process for the initial positioning in the X direction is executed as explained above. Although not explained here in detail, a process for initial positioning in the Y direction is also executed in a similar way. In the process for the initial positioning in the Y direction, the controller 6 calculates the difference between the output of the Y″(−) area made of the photoreceiving areas C and D and the output of the Y″(+) area made of the photoreceiving areas A and B (second output difference=(C+D)−(A+B)), and lets the second actuator 8 move the condenser lens 2 in the Y′ direction based on the second output difference. In the optical communication module 10 configured as above, a reference value for the second output difference (second reference value) is also set to 0 V.

After the spot on the incidence face 3a has moved to the core 3c as above, the controller 6 executes the real-time control in order to let the spot center coincide with the core center at all times. In the following, the real-time control will be described briefly.

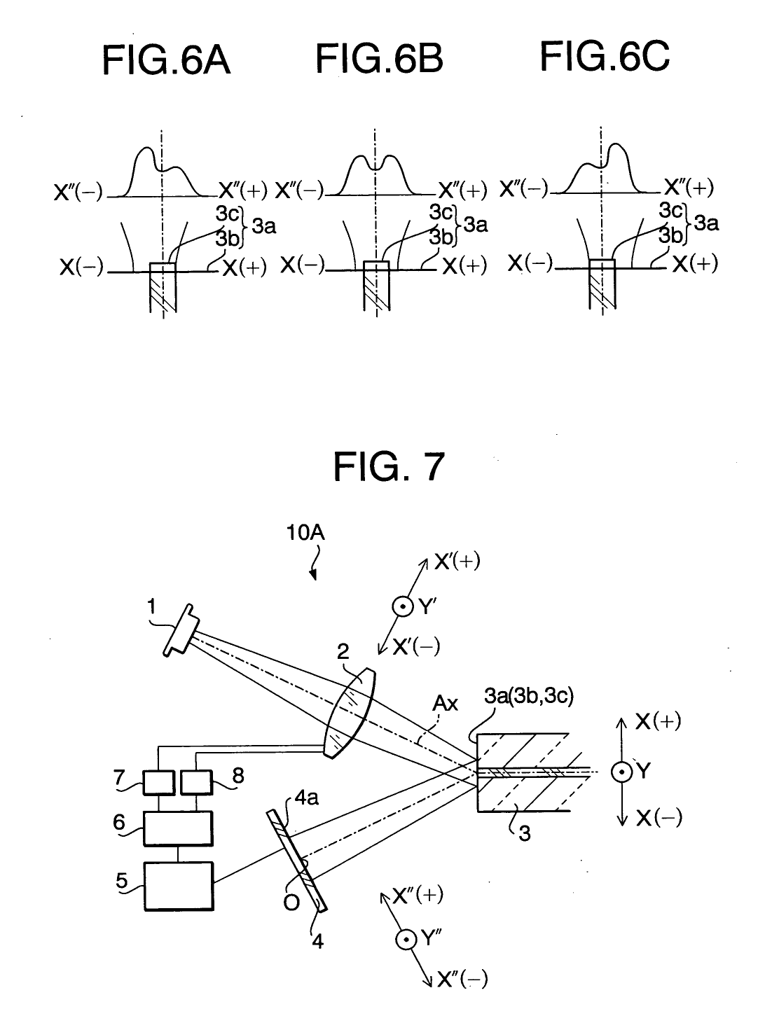

First, a principle for the real-time control executed by the controller 6 will be explained. FIGS. 6A-6C are schematic diagrams showing various incidence positions of the beam from the LD 1 on the incidence face 3a and the light intensity distribution (on the photoreceiving surface 4a) in the X″ direction when the beam from the LD 1 is incident upon each incidence position on the incidence face 3a. In the incidence face 3a shown in each figure, the left-hand side corresponds to the X(−) direction and the right-hand side corresponds to the X(+) direction. FIG. 6A shows a state in which the incidence position (spot center) of the beam from the LD 1 on the incidence face 3a is on the X(−) side of the core 3c and the light intensity distribution on the photoreceiving surface 4a in the state. FIG. 6C shows a state in which the incidence position (spot center) of the beam from the LD 1 on the incidence face 3a is on the X(+) side of the core 3c and the light intensity distribution in the state. FIG. 6B shows a state in which the incidence position of the beam from the LD 1 on the incidence face 3a substantially coincides with the core 3c and the light intensity distribution in the state.

As shown in FIGS. 6A-6C, the light intensity distribution on the photoreceiving surface 4a varies depending on the position of the spot on the incidence face 3a. In other words, the light intensity distribution changes corresponding to the shift of the spot from the core 3c. Therefore, the real-time control is executed by changing the position of the spot formed on the incidence face 3a so that the light intensity distribution will coincide with a reference distribution (light intensity distribution when the position of the spot (spot center) coincides with that of the core 3c (core center)). In this embodiment, the light intensity distribution shown in FIG. 6B corresponds to the reference distribution.

Incidentally, signal output of each photoreceiving area A-D (i.e. the amount of light received by each photoreceiving area A-D) is proportional to the integral of the light intensity distribution in the area. As shown in FIG. 5, due to the aforementioned change of light intensity distribution caused by diffraction, the relationship between the shift of the spot in the X direction and the first output difference in the vicinity of the core 3c is not the aforementioned linear relationship (used in the aforementioned initial positioning) but a relationship drawing a locus like S. Therefore, once the first output difference is obtained in the state or positional relationship of FIG. 4B, the position of the spot center can be uniquely determined within a particular range (FIGS. 6A-6C). Thus, the real-time control can also be executed by slightly changing the spot position so that the first output difference will be substantially equal to an output difference corresponding to the reference distribution (i.e. the first reference value=±0 V).

When the spot center on the incidence face 3a has shifted in the X(−) direction from the core 3c as shown in FIG. 6A, diffraction is caused by the level difference between the core 3c and the clad 3b and the light intensity distribution in the X″(−) area gets higher than that in the X″(+) area, by which the first output difference is obtained as a positive value. On the other hand, when the spot center has shifted in the X(+) direction from the core 3c as shown in FIG. 6C, diffraction is caused by the level difference and the light intensity distribution in the X″(+) area gets higher than that in the X″(−) area, by which the first output difference is obtained as a negative value.

When the spot center on the incidence face 3a coincides with the core center as shown in FIG. 6B, part of the beam from the LD 1 traveling on the optical axis is reflected at the center of the incidence face 3a of the optical fiber 3 and is then incident upon the center O of the photoreceiving surface 4a of the photodetector 4, by which the light intensity distribution in the X″(+) direction becomes substantially symmetrical to that in the X″(−) direction. In other words, the light intensity distribution substantially coincides with the reference distribution. Further, the outputs of the photoreceiving areas A-D become substantially equal and the first output difference diminishes to 0 V.

The controller 6 controls the position of the spot on the incidence face 3a by executing negative feedback control so that the current light intensity distribution (obtained by the outputs of the photoreceiving areas A-D) will substantially coincide with the reference distribution. Or the controller 6 finely adjusts the position of the spot on the incidence face 3a in the X direction by letting the first actuator 7 slightly move the condenser lens 2 in the X′ direction so as to reduce the first output difference to 0.

For example, when the spot and the core 3c are in a positional relationship shown in FIG. 6A, the shift in the X direction (the first output difference) is within a range (B 1) shown in FIG. 5. In this case, the controller 6 slightly moves the spot center in the X(+) direction so that the first output difference will be 0. When the spot and the core 3c are in a positional relationship shown in FIG. 6C, the shift in the X direction (the first output difference) is within a range (B2) shown in FIG. 5. In this case, the controller 6 slightly moves the spot center in the X(−) direction so that the first output difference will be 0. When the incidence position is at the core center as shown in FIG. 6B, that is, when the light intensity distribution coincides with the reference distribution (i.e. when the first output difference is 0 V), the controller 6, judging that the spot center coincides with the core center on the incidence face 3a and the optical transmission efficiency is at the maximum, does not drive the condenser lens 2 in the X direction.

As above, the controller 6 is capable of executing the high-precision positioning (for letting the beam from the LD 1 incident upon the core center of the incidence face 3a), by performing the real-time negative feedback control so as to reduce the first output difference to 0.

The real-time control in the X direction is executed by the controller 6 as explained above. The controller 6 also executes a positioning process regarding the Y direction according to a similar principle (detailed description thereof is omitted for brevity). In the positioning process regarding the Y direction, the shift of the spot on the incidence face 3a in the Y direction is determined based on the aforementioned second output difference. The controller 6 executes the real-time control in the Y direction by letting the second actuator 8 drive the condenser lens 2 in the Y′ direction so as to reduce the second output difference to 0.

The real-time control described above is executed not only in an initial adjustment in the manufacturing process of the optical communication module 10 but also after the power of the module 10 is turned on, during optical communication (constantly), etc. Therefore, even when the incidence position of the beam on the incidence face 3a shifts from the core 3c during optical communication, the controller 6 can correct the shift based on the output of the photodetector 4.

While the above explanation of the initial positioning process and the real-time control has been given discriminating between the X direction and the Y direction for convenience of explanation, the positioning processes regarding the X and Y directions are executed simultaneously in the actual optical communication module 10.

As described above, in the optical communication module 10 as an optical communication device in accordance with the embodiment of the present invention, the position of the spot on the incidence face 3a is controlled based on the output of the photodetector 4, by which the initial positioning for letting the beam (a signal beam to be transmitted through the optical fiber 3) be incident upon the core 3c of the optical fiber 3 can be executed simply and quickly. Further, the real-time control is executed using the diffraction pattern on the photoreceiving surface 4a caused by the level difference on the incidence face 3a, by which high-precision positioning is realized.

Incidentally, while the X and Y directions, indicating the moving directions of the spot formed on the incidence face 3a, have been assumed in the above embodiment to be orthogonal to each other for the sake of convenience, the angle between the X and Y directions is not limited to 90 degrees. In the optical communication device in accordance with the present invention, any X and Y directions can be defined unless they are parallel with each other.

While the incidence face 3a of the optical fiber 3 in the above embodiment is configured to let the core 3c protrude from the clad 3b for causing the diffraction of the beam from the LD 1 incident upon the incidence face 3a, similar effects can also be achieved by other configurations (e.g. letting the core 3c withdraw from the clad 3b by λ/8 as a concave part of the incidence face 3a).

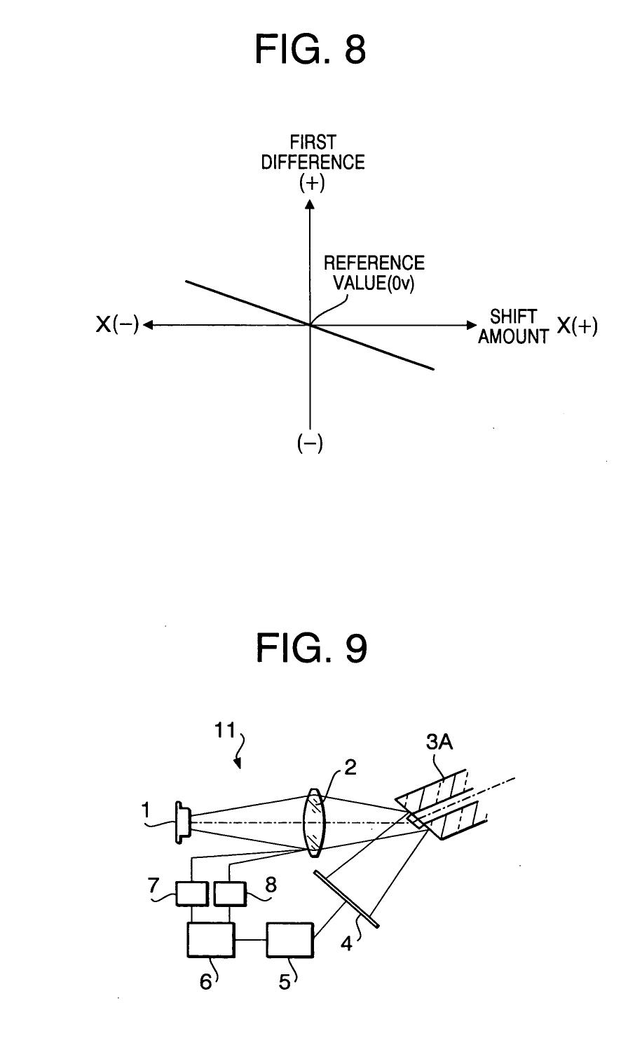

The optical communication device in accordance with the present invention is capable of quick initial positioning even with configurations other than that of the above embodiment. For example, while the state optimum for optical communication is maintained in the above embodiment by first leading the spot to the vicinity of the core 3c by the initial positioning and thereafter letting the spot center constantly coincide with the core center by the real-time control, the optical communication device may also be designed leaving out the real-time control to reduce costs as long as optical transmission efficiency sufficient for optical communication can be achieved by the initial positioning. Such an optical communication module 10A omitting the real-time control is shown in FIG. 7. Since the real-time control is left out, the optical communication module 10A does not need the diffraction of the beam reflected by the incidence face 3a; therefore, the level difference between the core 3c and the clad 3b on the incidence face 3a is unnecessary as shown in FIG. 7. In this case, the relationship between the first output difference and the shift in the X direction is substantially linear irrespective of whether the beam incidence position is in the vicinity of the core 3c or not, as shown in FIG. 8.

In the above embodiment, both the reference values for the first and second output differences (i.e. the first and second reference values) used in the initial positioning are defined as 0V and the reference distribution used in the real-time control is defined as a distribution in the state when the incidence position of the beam from the LD 1 substantially coincides with the position of the core 3c (i.e. a distribution in the state when the outputs of the photoreceiving areas A, B, C and D are in the ratio 1:1:1:1) for the sake of convenience. However, in actual devices, the first and second reference values do not necessarily reach 0 V even when the spot on the incidence face 3a lies in the vicinity of the core 3c, due to individual differences, etc. In such cases, initial positioning similar to that of the above embodiment can be realized by setting the first and second reference values at output differences obtained when the spot on the incidence face 3a lies in the vicinity of the core 3c. Similarly, even when the spot center on the incidence face 3a coincides with the core center, there are cases where the light intensity distributions in the X″ and Y″ directions do not exhibit the 1:1 output ratios (as in FIG. 6B) but deviate in the X″ direction or Y″ direction. In such cases, the initial positioning can be realized by employing the deviated distribution as the first or second reference distribution.

While the spot (formed on the incidence face 3a by the beam from the LD 1) is moved and positioned to the core 3c by driving the condenser lens 2 in the above embodiment, the mechanism for moving the spot is not restricted to that of the above embodiment. For example, the position of the spot on the incidence face 3a can also be changed by moving the LD 1 itself in the X″ and Y″ directions, without driving the condenser lens 2. The positioning of the spot on the incidence face 3a without driving the condenser lens 2 can also be realized by placing a variable deflecting member (e.g. variable apex angle prism) on the optical path between the LD 1 and the incidence face 3a and driving the deflecting member. Such a modification placing the deflecting member between the LD 1 and the incidence face 3a is especially suitable for configurations in which the driving of the condenser lens 2 is impossible (e.g. a module employing an LD and a condenser lens formed integrally).

FIG. 9 shows an optical communication module 11 as an example of modification of the optical communication module of FIG. 1, employing an optical fiber 3A cut along a plane not orthogonal to the lengthwise direction of the fiber. In the optical communication module 11, the optical elements are arranged so that the beam from the LD 1 will be incident upon the incidence face 3a at a nonzero incidence angle. Therefore, the optical communication module 11 has advantages of higher fiber coupling efficiency and an easier manufacturing process compared to the optical communication module 10. In consideration of refraction at the incidence face 3a, the optical fiber 3A of the optical communication module 11 is placed so that its optical axis will have a prescribed tilt angle with respect to the optical axis of the condenser lens 2.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

The present disclosure relates to the subject matter contained in Japanese Patent Application No. 2004-140624, filed on May 11, 2004, which is expressly incorporated herein by reference in its entirety.

1. An optical communication device comprising:
a light source which emits a beam of light modulated according to information;
an optical fiber having an incidence face upon which the beam is incident and transmitting the beam entering its core;
a condenser lens placed on an optical path of the beam between the light source and the optical fiber to condense the beam to let it form a spot on the incidence face;
a moving system which moves the spot on the incidence face in a first direction and a second direction which are not parallel with each other;
a photoreceiving system including a photoreceiving surface having first and second areas separated from each other by a first boundary line extending in a direction corresponding to the first direction and third and fourth areas separated from each other by a second boundary line extending in a direction corresponding to the second direction, outputting a signal corresponding to intensity of light received by each of the first through fourth areas after being reflected by the incidence face; and
a control system which controls the moving system to move the spot in the first direction so that a first output difference obtained by subtracting the output of the fourth area from that of the third area will be substantially equal to a first reference value while controlling the moving system to move the spot in the second direction so that a second output difference obtained by subtracting the output of the second area from that of the first area will be substantially equal to a second reference value.

2. The optical communication device according to claim 1, wherein:
the first output difference takes on a value larger than the first reference value when incidence position of the reflected beam on the photoreceiving surface has a shift toward the third area with reference to the second boundary line, and
the first output difference takes on a value smaller than the first reference value when the incidence position has a shift toward the fourth area with reference to the second boundary line.

3. The optical communication device according to claim 1, wherein:
the second output difference takes on a value larger than the second reference value when incidence position of the reflected beam on the photoreceiving surface has a shift toward the first area with reference to the first boundary line, and
the second output difference takes on a value smaller than the second reference value when the incidence position has a shift toward the second area with reference to the first boundary line.

4. The optical communication device according to claim 1, wherein the first direction and the second direction are orthogonal to each other.

5. The optical communication device according to claim 1, wherein the reflected beam from the center of the core is incident upon an intersection point of the first and second boundary lines when the first and second output differences coincide with the first and second reference values respectively.

6. The optical communication device according to claim 1, wherein at least one of the first and second reference values is 0.

7. The optical communication device according to claim 1, wherein the moving system moves the spot in the first direction and the second direction by moving the condenser lens in a direction perpendicular to an optical axis of the condenser lens.

8. The optical communication device according to claim 1, wherein the incidence face of the optical fiber is provided with a prescribed level difference between the core and a clad to cause diffraction to the reflected beam.

9. The optical communication device according to claim 8, wherein the level difference is set smaller than λ/(4n), where λ is a wavelength of the beam from the light source and n is a refractive index of a medium.

10. The optical communication device according to claim 8, wherein the incidence face is formed so that the surface of the core and that of the clad will be substantially parallel with each other.

11. The optical communication device according to claim 8, wherein the spot has a diameter larger than that of the core and smaller than that of the clad.

12. An optical communication device comprising:
a light source which emits a beam of light modulated according to information;
an optical fiber having an incidence face upon which the beam is incident and transmitting the beam entering its core;
a condenser lens placed on an optical path of the beam between the light source and the optical fiber to condense the beam to let it form a spot on the incidence face;
a moving system which moves the spot on the incidence face in a first direction and a second direction which are not parallel with each other;
a photoreceiving system which outputs a signal corresponding to a distribution of intensity of light received by its photoreceiving surface after being reflected by the incidence face; and
a control system which controls the moving system to move the spot in the first direction and the second direction so as to lead the spot to the core based on the light intensity distribution represented by the signal outputted by the photoreceiving system.

13. An optical communication device comprising:
a light source which emits a beam of light modulated according to information;
an optical fiber having an incidence face upon which the beam is incident and transmitting the beam entering its core;
a condenser lens placed on an optical path of the beam between the light source and the optical fiber to condense the beam to let it form a spot on the incidence face;
a moving system which moves the spot on the incidence face in a first direction and a second direction which are not parallel with each other;
a photoreceiving system including a photoreceiving surface having a plurality of two-dimensionally arranged areas; and
a control system which controls the moving system to move the spot to a predetermined position on the photoreceiving surface in accordance with outputs of the plurality of two-dimensionally arranged areas.

14. The optical communication device according to claim 13, wherein the moving system moves the spot by shifting the condenser lens in a direction orthogonal to an optical axis of the condenser lens.
